(19) United States
(12) Patent Application Publication
(10) Pub. No.: US 2025/0109247 A1
(43) Pub. Date: Apr. 3, 2025

(54) METHOD FOR PRODUCING POLYSUCCINIMIDE, POLYSUCCINIMIDE COMPOSITION, AND POLYASPARTIC ACID COMPOSITION

(71) Applicant: DIC Corporation, Tokyo (JP)

(72) Inventors: Hisakazu Tanaka, Sakura-shi (JP); Manabu Kambara, Sakura-shi (JP)

(73) Assignee: DIC Corporation, Tokyo (JP)

(21) Appl. No.: 18/901,413

(22) Filed: Sep. 30, 2024

(30) Foreign Application Priority Data
Oct. 3, 2023 (JP) 2023-172282

(51) Int. Cl. C08G 73/10

(52) U.S. Cl. CPC C08G 73/1003; C08G 73/1092

(57) ABSTRACT

Provided is a method for producing a polysuccinimide that can simply produce a high molecular weight polysuccinimide. The method for producing a polysuccinimide is a method for producing a polysuccinimide in which a second polysuccinimide is produced using a polysuccinimide composition containing a first polysuccinimide. The method includes: performing a chain elongation reaction of the first polysuccinimide to obtain the second polysuccinimide. The first polysuccinimide has a weight average molecular weight (Mw) falling within a range of 25,000 to 50,000. The polysuccinimide composition contains dicarboxylic acid at a ratio of 1.5 mol % to 4 mol %.

### BACKGROUND OF THE INVENTION

### 1. Field of the Invention

The present invention relates to a method for producing a polysuccinimide, a polysuccinimide composition, and a polyaspartic acid composition.

### 2. Description of the Related Art

A polyaspartic acid obtained by hydrolysis of polysuccinimide is a biodegradable polycarboxylic acid and has a chemical structure similar to that of polyacrylic acid, and therefore is expected as a substitute material. As a method for producing a polyaspartic acid from aspartic acid, a method for producing a polyaspartic acid by producing a polysuccinimide, followed by hydrolysis with an alkali, or the like, has been known.

Examples of a method for producing a polysuccinimide include a method for producing polysuccinimide by a dehydration-condensation reaction of aspartic acid with an acid catalyst (for example, Japanese Unexamined Patent Application Publication No. 8-231710).

However, a produced polysuccinimide generally has a low molecular weight, is used only in particular application, and even if used, cannot achieve so high performance. As a countermeasure, as a method for producing a high molecular weight polysuccinimide, a method for producing a high molecular weight polysuccinimide-based (co)polymer by adding a catalyst and a polymerization promoter to a polymerization system, resulting in polymerization is disclosed (for example, Japanese Unexamined Patent Application Publication No. 9-302088). Further, there is disclosed a method in which a mixture containing aspartic acid and an acidic catalyst is polymerized and condensed to produce a low molecular weight solid polymer mixture containing a low molecular weight polysuccinimide, an acidic catalyst is then added and mixed, and polycondensation is caused to produce a high molecular weight polysuccinimide (for example, Japanese Unexamined Patent Application Publication No. 2001-335635).
PTL 1: Japanese Unexamined Patent Application Publication No. 8-231710
PTL 2: Japanese Unexamined Patent Application Publication No. 9-302088
PTL 3: Japanese Unexamined Patent Application Publication No. 2001-335635

### SUMMARY OF THE INVENTION

However, the weight average molecular weight of a polysuccinimide obtained in Japanese Unexamined Patent Application Publication No. 9-302088 is about 30,000 to about 43,000. Therefore, there is a demand for a polysuccinimide having a further high molecular weight. The method in Japanese Unexamined Patent Application Publication No. 2001-335635 is complicated, and is not necessarily a satisfactory industrial production method.

An object to be achieved by the present invention is to provide a method for producing a polysuccinimide that can simply produce a polysuccinimide having a high molecular weight (for example, weight average molecular weight: 100,000 to 500,000).

The contents of the present invention include the following embodiments.

[1]A method for producing a polysuccinimide in which a second polysuccinimide is produced using a polysuccinimide composition containing a first polysuccinimide, the method including:
performing a chain elongation reaction of the first polysuccinimide to obtain the second polysuccinimide,
the first polysuccinimide having a weight average molecular weight (Mw) falling within a range of 25,000 to 50,000, the polysuccinimide composition containing dicarboxylic acid at a ratio of 1.5 mol % to 4 mol %.

[2] The method for producing a polysuccinimide according to [1], the method further including:
performing a polycondensation reaction of aspartic acid to obtain the polysuccinimide composition containing the first polysuccinimide composition, as a first step, before the chain elongation reaction, as a second step, wherein
the first step and the second step are performed using different devices.

[3] The method for producing a polysuccinimide according to [2], wherein at a stage in which the weight average molecular weight (Mw) of the first polysuccinimide in the first step falls within a range of 25,000 to 50,000 and the ratio of dicarboxylic acid in the first polysuccinimide falls within a range of 1.5 mol % to 4 mol %, the first step ends and proceeds to the second step.

[4] The method for producing a polysuccinimide according to [3], wherein the first step is performed using a continuous kneader.

[5] The method for producing a polysuccinimide according to any one of [1] to [4], wherein the second step is performed using at least one device selected from the group consisting of a hot-air-transferring dryer, a material-stirring dryer, a fluidized bed dryer, a material-ventilation and transferring dryer, a cylindrical dryer, an infrared ray dryer, a microwave dryer, and an overheated-steam dryer.

[6]A polysuccinimide composition containing a second polysuccinimide having a weight average molecular weight falling within a range of 100,000 to 500,000, the polysuccinimide composition being obtained by the method for producing a polysuccinimide according to any one of [1] to [5].

[7]A polyaspartic acid composition that is a hydrolysate of the polysuccinimide composition according to [6].

[8]A cross-linked polyaspartic acid composition that is a cross-linking reaction product of the polyaspartic acid composition according to [7].

[9]A thickener for a cosmetic material containing the cross-linked polyaspartic acid composition according to [8].

[10]A water-absorbing composition containing the cross-linked polyaspartic acid composition according to [8].

### DETAILED DESCRIPTION OF EMBODIMENTS

### (Method for Producing Polysuccinimide)

A method for producing a polysuccinimide of an embodiment of the present invention (referred to as the method for producing a polysuccinimide of the embodiment or simply referred to as the production method of the embodiment) is a method for producing a polysuccinimide in which a second polysuccinimide is produced using a polysuccinimide composition containing a first polysuccinimide. The method includes performing a chain elongation reaction of the first polysuccinimide to obtain the second polysuccinimide. The first polysuccinimide has a weight average molecular weight (Mw) falling within a range of 25,000 to 50,000, and the polysuccinimide composition contains dicarboxylic acid at a ratio of 1.5 mol % to 4 mol %. It is preferable that the method further include performing a polycondensation reaction of aspartic acid to obtain the polysuccinimide composition containing the first polysuccinimide composition, as a first step, before the chain elongation reaction, as a second step. It is preferable that the first step and the second step be performed using different reactors.

### [Aspartic Acid]

The aspartic acid according to the embodiment may be L-aspartic acid, which is naturally abundant, D-aspartic acid, or a mixture thereof. The aspartic acid may be any of L-aspartic acid, D-aspartic acid, or DL-aspartic acid.

The aspartic acid may have a form of a salt of aspartic acid, or an anhydride or a hydrate (for example, monohydrate or dihydrate) of aspartic acid or a salt thereof as long as they can be converted to aspartic acid in the reaction system of the first step.

### [Polysuccinimide and Polysuccinimide Composition]

The structure of the polysuccinimide according to the embodiment may be a linear structure or have a branched structure.

The polysuccinimide composition containing the first polysuccinimide according to the embodiment (referred to as the first polysuccinimide composition) is a mixture of a reaction product obtained in the first step of the method for producing a polysuccinimide of the embodiment. The first polysuccinimide composition contains the first polysuccinimide, which is the reaction product in the first step, and if necessary, may contain a catalyst and a solvent blended or may contain unreacted aspartic acid depending on a reaction condition.

In the first step, the content of the first polysuccinimide in the first polysuccinimide composition depends on the reaction condition and is not limited. The content may be, for example, 45 mass % or more, 50 mass % or more, or 55 mass % or more. The content may be 80 mass % or less, 70 mass % or less, or 65 mass % or less.

It is noted that the term “first polysuccinimide” is a term for distinguishing a final polysuccinimide (second polysuccinimide) obtained in the second step of the production method of the embodiment, and means a crude polysuccinimide or a precursor of the second polysuccinimide. In the production method of the embodiment, the second polysuccinimide has a higher weight average molecular weight than the first polysuccinimide. The ratio (Mw1/Mw2) of the weight average molecular weight (Mw1) of the first polysuccinimide to the weight average molecular weight (Mw2) of the second polysuccinimide may be 1.2 or more, 1.5 or more, or 2.0 or more. The ratio is preferably 2.5 or more, and more preferably 3.0 or more. The ratio may be 10.0 or less, or 7.0 or less.

The weight average molecular weight (Mw) of the first polysuccinimide preferably falls within a range of 25,000 to 50,000, more preferably falls within a range of 25,000 to 45,000, and further preferably falls within a range of 25,000 to 40,000.

A method for measuring the weight average molecular weight of the polysuccinimide will be described in detail in Examples.

The ratio of dicarboxylic acid in the first polysuccinimide composition is preferably 1.5 mol % to 4 mol %, more preferably 2 mol % to 4 mol %, and further preferably 2.5 mol % to 4 mol %.

A method for measuring the ratio of dicarboxylic acid in the first polysuccinimide composition will be described in detail in Examples.

It is preferable that the weight average molecular weight (Mw) of the first polysuccinimide fall within a range of 25,000 to 50,000 and the ratio of dicarboxylic acid in the polysuccinimide composition be 1.5 mol % to 4 mol %. It is more preferable that the weight average molecular weight (Mw) of the first polysuccinimide fall within a range of 25,000 to 45,000 and the ratio of dicarboxylic acid in the polysuccinimide composition be 2 mol % to 4 mol %. It is further preferable that the weight average molecular weight (Mw) of the first polysuccinimide fall within a range of 25,000 to 40,000 and the ratio of dicarboxylic acid in the polysuccinimide composition be 2.5 mol % to 4 mol %.

The weight average molecular weight of the polysuccinimide (second polysuccinimide) obtained by the method for producing a polysuccinimide of the embodiment may fall within a range of 100,000 to 500,000, or 110,000 to 300,000, or 120,000 to 200,000.

### [Performing Polycondensation Reaction (First Step)]

In the method for producing a polysuccinimide of the embodiment, the chain elongation step (second step) described in detail below may be performed using the predetermined first polysuccinimide as it is. The method preferably includes performing a polycondensation reaction as the first step before the chain elongation reaction. The first step includes a polycondensation reaction using aspartic acid as a raw material, or a thermal polymerization of at least one kind of acid selected from the group consisting of maleic acid, fumaric acid, and malic acid and an ammonium salt and/or amide. Specific examples of the polycondensation reaction using aspartic acid as a raw material include solid phase polymerization, soluble solvent polymerization, and insoluble solvent polymerization, and solid phase polymerization is preferred among these.

The solid phase polymerization includes a direct thermal polycondensation reaction of aspartic acid in a solid phase state.

In the first step of the production method of the embodiment, the preparation of the polysuccinimide composition containing the first polysuccinimide obtained by the solid phase polymerization of aspartic acid is advantageous to the chain extension reaction in the second step of the production method of the embodiment.

In the first step of the method for producing a polysuccinimide of the embodiment, the polycondensation reaction of aspartic acid is preferably polycondensing a mixture of aspartic acid and an acidic catalyst.

In the embodiment, the term “polycondensation” means polycondensation in which two water molecules are removed from aspartic acid to produce a polysuccinimide. Provided that the polycondensation may include a side reaction and an intermediate-producing reaction, in addition to the aforementioned reaction. Examples thereof include amidation in which before formation of an imide ring by cyclization, one water molecule is removed from aspartic acid to produce an amide, and a reaction for removal of ammonia from aspartic acid. That is, in the first step of the embodiment, a polymer (first polysuccinimide) having a succinimide structure as a repeating unit is synthesized. However, the final product in the first step of the embodiment is the polysuccinimide composition containing the polymer (first polysuccinimide). The polysuccinimide composition may have a monomer unit that is contained in the side reaction and the like. The polysuccinimide composition may contain unreacted aspartic acid.

### <Acidic Catalyst>

The acidic catalyst according to the embodiment is not particularly limited, and examples thereof include phosphorus oxoacid, sulfuric acid, sulfurous acid, alkylsulfonic acid, arylsulfonic acid, chloric acid, chlorous acid, hypochlorous acid, bromic acid, bromous acid, hypobromous acid, iodic acid, iodous acid, hypoiodous acid, molybdic acid, tungstic acid, hydrochloric acid, hydrogen sulfide, hydrogen bromide, sodium bisulfate, potassium bisulfate, ammonium bisulfate, and fluorosulfuric acid.

The acidic catalyst according to the embodiment is particularly preferably phosphorus oxoacid. Specific examples of phosphorus oxoacid include orthophosphoric acid, metaphosphoric acid, pyrophosphoric acid, polyphosphoric acid, phosphorus pentoxide, hypophosphorous acid, orthophosphorous acid, heterophosphorous acid, pyrophosphorous acid, hypophosphoric acid, heterophosphoric acid, pyrophosphoric acid, alkylphosphonic acid, arylphosphonic acid, a phosphoric acid ester having at least one acidic hydrogen atom, and a phosphorous acid ester having at least one acidic hydrogen atom. One kind of the compounds may be used alone or two or more kinds thereof may be used in combination. Among these, the phosphorus oxoacid, which is in a solution state or a slurry state, once under a reaction condition and can uniform disperse aspartic acid or a condensate thereof is preferred, and orthophosphoric acid and polyphosphoric acid are particularly preferred.

The acidic catalyst may be in a diluted state with a solvent (for example, a polar solvent such as water, alcohol, and ketone). The acidic catalyst may be used at an acidic catalyst concentration of preferably 50 mass % or more, more preferably 60 mass % or more, particularly preferably 70 mass % or more, and the most preferably 80 mass % or more, and preferably 90 mass % or less. For example, when a phosphoric acid is used, the concentration of a phosphoric acid solution is preferably 60 mass % or more, more preferably 80 mass % or more, and particularly preferably 85 mass % or more. When the acidic catalyst concentration is moderately high, the amount of solvent removed during a polymerization operation is generally small, which is advantageous in terms of energy saving.

### <Reactor>

In the first step according to the embodiment, for example, when the acidic catalyst is used, a method for mixing a mixture containing aspartic acid and the acidic catalyst is not particularly limited. A method that can uniformly mix both aspartic acid and the acidic catalyst may be appropriately used. Since the amount of the acidic catalyst in the first step is insufficient to completely dissolve aspartic acid at room temperature or a reaction temperature, mixing with stirring is preferred. In particular, in industrial terms, mechanical mixing suitable to mixing large amounts of solid and liquid is preferred.

A mixer used in mechanical mixing is not particularly limited, and various conventionally known batch mixers and continuous mixers can be used. Specific examples of a batch mixer include a double planetary mixer, a double-arm kneader, and a stationary tank mixer such as a gate mixer, a shear bar mixer, or a helical blade mixer. Examples thereof include a bulk blender such as a ribbon blender, a cone and screw mixer, a pan muller mixer, and a plough mixer. Specific examples of a continuous mixer include single-screw and twin-screw mixers and a pug mill.

In the first step according to the embodiment, when the acidic catalyst is used, the polycondensation reaction of aspartic acid may be performed after the mixture containing aspartic acid and the acidic catalyst is mixed, or the polycondensation reaction of aspartic acid may be performed while the mixture containing aspartic acid and the acidic catalyst is mixed.

The polycondensation reaction of aspartic acid is preferably solid phase polymerization. A device for performing solid phase polymerization is not particularly limited, and examples thereof include a batch or continuous device. The batch device and the continuous device may be each vertical or lateral. Examples of the device for performing solid phase polymerization include a device for performing a continuous operation or a batch operation. The solid phase polymerization may be performed, for example, using at least one device selected from the group consisting of a hot-air-transferring dryer, a material-stirring dryer (a fluidized bed dryer, etc.), a material-ventilation and transferring dryer, a cylindrical dryer, an infrared ray dryer, a microwave dryer, and an overheated-steam dryer. The solid phase polymerization may be performed, for example, using at least one device selected from the group consisting of a fluidized bed reactor, a moving bed reactor, a fixed bed reactor, and a stirring dryer-type reactor.

### [Feed Rate (Discharge Amount)]

The first step according to the embodiment is preferably performed using a continuous kneader. A continuous kneader having a heating mechanism such as a jacket or an electric heater capable of heating the inside thereof is preferred. The configuration of stirring blades for mixing may be a single shaft or a multi-shaft such as two or more shafts. Examples of a preferable configuration of the continuous kneader having such a configuration include a twin-screw extruder (extruder), which is collectively referred to as a so-called extruder, and a twin-screw continuous kneader.

The feed rate (discharge amount) of the continuous kneader varies depending on the size of the continuous kneader, and thus it is impossible to say generally the feed rate. The feed rate needs to be selected so that the weight average molecular weight (Mw) of the first polysuccinimide falls within a range of 25,000 to 50,000. In general, as the feed rate is lower, the weight average molecular weight of the resultant polysuccinimide is larger, and as the feed rate is higher, the weight average molecular weight is smaller. Further, as the residence time in the kneader is longer, the molecular weight is larger, which is restricted by the kneader. Furthermore, the screw rotation speed also affects the molecular weight, and as the rotation number is higher, a higher shear energy is applied, and the molecular weight is larger. It is possible to control the weight average molecular weight of the polysuccinimide and the amount of dicarboxylic acid by controlling the feed rate, the rotation number, and a reaction temperature described below.

### <Solvent>

An operation of mixing a raw material (aspartic acid, and the acidic catalyst when the acidic catalyst is used) in the first step according to the embodiment is generally performed by mixing the raw material as it is. In some cases, the operation may be performed by dissolving or dispersing aspartic acid and/or the acidic catalyst in a solvent (a polar solvent such as water, alcohol, or ketone). It is preferable that the solvent other than water be sufficiently removed from the system before the initiation of the reaction to prevent a side reaction. In addition, an operation of mixing the acidic catalyst with aspartic acid can be efficiently performed using water produced by a condensation reaction of aspartic acid.

### <Reaction Temperature>

In the first step according to the embodiment, when the acidic catalyst is used, a temperature at which the mixture containing aspartic acid and the acidic catalyst is mixed is not particularly limited. When aspartic acid and the acidic catalyst are sufficiently mixed and polycondensation is then performed, a mixing method at a low temperature such as room temperature may be performed. Mixing at a temperature at which polycondensation does not abruptly proceed is an effective mixing method. This is because raising the temperature increases the solubility of aspartic acid, and part of aspartic acid is converted to polysuccinimide, resulting in an increase in solubility in the acidic catalyst, and uniform mixing is possible.

In the first step according to the embodiment, when the acidic catalyst is used, the mixture containing aspartic acid and the acidic catalyst prepared in advance is subjected to copolymerization at 150° C. to 230° C. The temperature at that time is preferably 170° C. to 225° C., and more preferably 190° C. to 220° C. A moderate increase in the temperature can increase the polymerization degree and shorten the process time. On the contrary, a moderate decrease in the temperature can prevent thermal decomposition and a side reaction.

In the first step according to the embodiment, when the acidic catalyst is used, polycondensation may be performed by increasing the temperature to the polycondensation temperature while the mixture containing aspartic acid and the acidic catalyst is mixed.

### <Reaction Pressure>

In the first step according to the embodiment, the pressure in the system when the polycondensation reaction is performed may a normal pressure or a slightly applied pressure, or a negative pressure. The former is, for example, a method in which produced water is distilled off with a stream of an inert gas, and the latter is, for example, a method in which the vapor pressure of produced water is reduced and the produced water is distilled off. In these methods, the state of the polymer mixture may be a state in which the polymerization degree sufficient for use as a solid can be achieved and a subsequent step allows the polymerization degree to proceed to an intended polymerization degree.

When solid phase polymerization is performed using an inert gas, it is preferable that the inert gas be continuously supplied to the reaction system. In this case, the inert gas is brought into contact with the mixture in a counter-current or co-current manner. The mixture may be heated by direct contact using the inert gas as a medium for heat transfer.

When the inert gas is used, the pressure in the reaction system may be any of a negative pressure system, a normal pressure system, and a pressurized system. The pressure is preferably 1 [Pa] to 5×10⁷ [Pa], more preferably 1×10 [Pa] to 1×10⁷ [Pa], and particularly preferably 1×10² [Pa] to 5×10⁶ [Pa]. In the case of the pressurized system, a moderate reduction in the pressure does not require a highly pressure-resistant reactor. In contrast, even in the case of the negative pressure system, a moderate increase in the pressure does not require the design of a device corresponding to high vacuum.

In the first step according to the embodiment, an operation for solid phase polymerization in a normal pressure system is preferably performed with a stream of an inert gas. The use amount of the inert gas falls within a range of 0.0001 L/min to 100 L/min, preferably 0.001 L/min to 60 L/min, more preferably 0.01 L/min to 40 L/min, particularly preferably 0.05 L/min to 30 L/min, and the most preferably 0.5 L/min to 20 L/min. Examples of the inert gas include nitrogen.

The use amount of the inert gas with respect to 1 kg of aspartic acid, which is a starting material in the first step, is 4.5 L/min to 90 L/min, preferably 10 L/min to 50 L/min, and more preferably 20 L/min to 30 L/min.

### <Reaction Time>

The time required in the first step according to the embodiment varies depending on L/D, the feed rate, and the rotation speed of a reaction portion of the continuous kneader, and the like, but is generally 0.017 hours to 1 hour, preferably 0.033 hours to 0.5 hours, more preferably 0.05 hours to 0.33 hours, and particularly preferably 0.083 hours to 0.25 hours.

In the first step according to the embodiment, it is preferable that at a stage in which the weight average molecular weight (Mw) of the first polysuccinimide contained in a product of the first step obtained by a reaction under a reaction condition appropriately selected from the aforementioned reaction conditions (acidic catalyst, reactor, reaction temperature, reaction pressure, reaction time, etc.) falls within a range of 25,000 to 50,000 and the ratio of dicarboxylic acid in the polysuccinimide composition falls within a range of 1.5 mol % to 4 mol %, the first step end. It is preferable that the polysuccinimide composition, which is the product, be transferred to a second step described below as it is. The preferable ranges of the weight average molecular weight (Mw) of the first polysuccinimide and the ratio of dicarboxylic acid in the polysuccinimide composition are the same ranges described in the product of the first step.

### [Performing Chain Elongation Reaction (Second Step)]

In the chain elongation reaction (second step) according to the embodiment, the chain elongation reaction of the polysuccinimide means that the weight average molecular weight of the first polysuccinimide is increased (the molecular weight is increased). A method for increasing the weight average molecular weight is not particularly, and the main chain of the polysuccinimide may be elongated, or the side chain of the polysuccinimide may be elongated. In the chain elongation reaction, the first polysuccinimide may be bonded (for example, cross-linked) to another first polysuccinimide. In the chain elongation reaction of the polysuccinimide according to the embodiment, chain-elongation may be performed by cross-linking with a cross-linker. However, it is preferable that the method do not include a cross-linking reaction with a cross-linker. Herein, the expression “not include a cross-linking reaction” means that in the product produced by the production method of the embodiment, the content a polysuccinimide produced by a cross-linking reaction be 0 mass % to 10 mass %, 0 mass % to 5 mass %, or 0 mass % to 1 mass %.

In the chain elongation reaction (second step) according to the embodiment, examples of the chain elongation reaction of the polysuccinimide include a dehydration-condensation reaction. For examples, the first polysuccinimide obtained in the first step can be subjected to a dehydration-condensation reaction to increase the weight average molecular weight of the polysuccinimide (to increase the molecular weight), and thus a second polysuccinimide can be obtained.

### <Reactor>

The second step according to the embodiment is performed using a reactor different from that in the first step.

In the second step according to the embodiment, a reactor used for the chain elongation reaction is not particularly limited, and examples thereof a hot-air-transferring dryer, a material-stirring dryer (a fluidized bed dryer, etc.), a material-ventilation and transferring dryer, a cylindrical dryer, an infrared ray dryer, a microwave dryer, and an overheated-steam dryer. The aforementioned reactors are suitable for the dehydration-condensation reaction of the polysuccinimide. In the second step according to the embodiment, the reactor used for the chain elongation reaction is more preferably one selected from the group consisting of a vacuum dryer, a conical dryer, a vibration dryer, and a fluidized bed dryer. A vacuum dryer is further preferred.

### <Solvent>

In the second step according to the embodiment, a solvent other than water may be added, if necessary. However, when the first polysuccinimide obtained in the first step is dehydrated and condensed to increase the molecular weight, it is preferable that the solvent be not added to the polysuccinimide composition obtained in the first step.

### <Reaction Temperature>

In the second step according to the embodiment, the reaction temperature is preferably 150° C. or higher, more preferably 170° C. or higher, and further preferably 190° C. or higher. The reaction temperature is preferably 230° C. or lower, more preferably 225° C. or lower, and further preferably 220° C. or lower.

### <Reaction Pressure>

In the second step according to the embodiment, the pressure in the system when the chain elongation reaction of the polysuccinimide is performed may a normal pressure or a slightly applied pressure, or a negative pressure.

When solid phase polymerization is performed using an inert gas, it is preferable that the inert gas be continuously supplied to the reaction system. In this case, the inert gas is brought into contact with the mixture in a counter-current or co-current manner. The mixture may be heated by direct contact using the inert gas as a medium for heat transfer.

When the inert gas is used, the pressure in the reaction system may be any of a negative pressure system, a normal pressure system, and a pressurized system. The pressure is preferably 1 [Pa] to 5×10⁷ [Pa], more preferably 1×10 [Pa] to 1×10⁷ [Pa], and particularly preferably 1×10² [Pa] to 5×10⁶ [Pa]. In the case of the pressurized system, a moderate reduction in the pressure does not require a highly pressure-resistant reactor. In contrast, even in the case of the negative pressure system, a moderate increase in the pressure does not require the design of a device corresponding to high vacuum.

In the second step according to the embodiment, an operation for solid phase reaction in a normal pressure system is preferably performed with a stream of an inert gas. The use amount of the inert gas falls within a range of 0.0001 L/min to 100 L/min, preferably 0.001 L/min to 60 L/min, more preferably 0.01 L/min to 40 L/min, particularly preferably 0.05 L/min to 30 L/min, and the most preferably 0.5 L/min to 20 L/min. Examples of the inert gas include nitrogen.

The use amount of the inert gas with respect to 1 kg of polysuccinimide composition, which is a starting material in the second step, is 4.5 L/min to 90 L/min, preferably 10 L/min to 50 L/min, and more preferably 20 L/min to 30 L/min.

### <Reaction Time>

The time required in the second step according to the embodiment is not particularly limited, but is generally 0.5 hours to 10 hours, preferably 1 hour to 8 hours, and more preferably 2 hours to 7 hours.

### [Post-Treatment Step]

The method for producing a polysuccinimide of the embodiment may further include a post-treatment step in addition to the first step and the second step. Examples of a post-treatment include removal of the acidic catalyst, which is used in the first step. For example, the polysuccinimide composition containing the second polysuccinimide and the acidic catalyst (a second polysuccinimide composition) can be subjected to a cleaning operation at 10° C. to 300° C. using a poor solvent (methanol, isopropanol, acetone, water, etc.) for a polysuccinimide to remove the acidic catalyst. The cleaning liquid containing the acidic catalyst can be reused in the aforementioned cleaning operation by a purification operation, if necessary, or without a purification operation.

When the acidic catalyst is used in the first step, after the second step according to the embodiment, the acidic catalyst contained in the mixture of the reaction product may be dissolved in a good solvent (dimethylformamide (DMF), dimethylsulfoxide, etc.) for a polysuccinimide once, then reprecipitated with a poor solvent (methanol, isopropanol, acetone, water, etc.) for the polysuccinimide, filtered, and if necessary, rinsed with the poor solvent, cleaned, and removed.

### (Polysuccinimide Composition)

A polysuccinimide composition of an embodiment of the present invention is the polysuccinimide composition (second polysuccinimide composition) containing the second polysuccinimide obtained by the method for producing a polysuccinimide of the aforementioned embodiment. The weight average molecular weight of the second polysuccinimide falls within a range of 100,000 to 500,000. The weight average molecular weight of the second polysuccinimide preferably falls within a range of 110,000 to 300,000, and more preferably falls within a range of 120,000 to 200,000.

The polysuccinimide composition containing the second polysuccinimide may further contain the acidic catalyst mixed in the first step, in addition to the second polysuccinimide.

### (Polyaspartic Acid Composition)

A polyaspartic acid composition of an embodiment of the present invention (a polyaspartic acid composition of the embodiment) is a hydrolysate of the polysuccinimide composition containing the second polysuccinimide obtained by the method for producing a polysuccinimide of the aforementioned embodiment.

The polyaspartic acid composition of the embodiment can be produced by hydrolyzing the second polysuccinimide through a publicly known hydrolysis reaction method (for example, Journal of Polymer Science: Part A: Polymer Chemistry, Vol. 38, 117-122 (2000)). It is preferable that the second polysuccinimide be hydrolyzed in the coexistence of an amine compound or the like to obtain the polyaspartic acid composition containing an added amine compound as a preferable form. Preferable examples of the amine compound include an alkylamine having any carbon atoms, a hydroxyamine having any carbon atoms, and a dialkylamine compound. Among these, dodecylamine, 3-amino-1-propanol, 1,2-bis(2-aminoethoxy)ethane, lysine, ornithine, and arginine, and hydrochlorides such as lysine hydrochloride, ornithine hydrochloride, and arginine hydrochloride, and similar sulfates are more preferred.
NPL A: Journal of Polymer Science: Part A: Polymer Chemistry, Vol. 38, 117-122 (2000)

A method for producing the polyaspartic acid composition of the embodiment includes, for example, a step of adding an aqueous alkaline solution to the polysuccinimide composition containing the second polysuccinimide obtained by the method for producing a polysuccinimide of the embodiment in the coexistence of an amine compound having one or more amino groups in the molecule, a hydrochloride thereof, and a sulfate thereof, resulting in hydrolysis of the polysuccinimide, to obtain a polyaspartic acid composition containing an amine compound and the like.

The pH at 25° C. of the aqueous alkaline solution is preferably 10 to 14, and more preferably 12 to 14.

Specific examples of the aqueous alkaline solution include an aqueous solution of a hydroxide or carbonate of alkali metal or alkaline earth metal, and ammonia water. In particular, an aqueous solution of NaOH, KOH, or LiOH is preferred, and an aqueous solution of NaOH is more preferred. The concentration of a base in the aqueous alkaline solution is not particularly limited, but a 0.5 mass % to 50 mass % solution is generally preferred.

The use amount of the aqueous alkaline solution needs to be an amount sufficient to convert the polysuccinimide obtained by the method for producing a polysuccinimide of the embodiment to a polyaspartic acid salt. The use amount is not particularly limited as long as the amount by mole of a used base falls within a range of 90% to 120% of the total amount by mole of carboxy groups and imide groups in the polysuccinimide.

The temperature during a treatment with the aqueous alkaline solution is not limited as long as it is a temperature at which a polymer main chain is not hydrolyzed, but in general, it is preferably 10° C. to 70° C., and more preferably 40° C. to 60° C. The time during the treatment with the aqueous alkaline solution is preferably 1 hour to 6 hours.

The polyaspartic acid salt aqueous solution obtained as described above may be used as it is, and a powder (that is, polyaspartic acid salt powder) may also be obtained by a freeze-drying means or the like. In addition, a polyaspartic acid may also be obtained by appropriate neutralization with an acid.

### (Cross-Linked Polyaspartic Acid Composition)

A cross-linked polyaspartic acid composition of an embodiment of the present invention (a cross-linked polyaspartic acid of the embodiment) is a cross-linked reaction product of the polyaspartic acid composition. The polyaspartic acid composition is obtained from the polysuccinimide composition of the embodiment by the same method as the method described in the section of (Polyaspartic Acid Composition) described above.

The polyaspartic acid composition can be cross-linked by a publicly known cross-linking reaction, to produce a first cross-linked polyaspartic acid composition of the embodiment. The cross-linked polyaspartic acid composition may be produced by a method for producing the cross-linked polyaspartic acid composition described below. In the method for producing the cross-linked polyaspartic acid composition, for example, the aqueous alkaline solution is added to the polysuccinimide composition containing the second polysuccinimide obtained by the method for producing a polysuccinimide of the embodiment in the coexistence of an amine compound, or the hydrochloride thereof, or the sulfate thereof, resulting in hydrolysis of the polysuccinimide, to obtain the polyaspartic acid composition containing an added amine compound and the like. Next, to the obtained polyaspartic acid composition, cross-linkers such as a polyfunctional epoxy and a diamine compound are then added, resulting in a reaction of an amino group contained in a residue of the amine compound added to the polyaspartic acid skeleton (in the case of the multifunctional epoxy) with a carboxy group of the main chain of the polyaspartic acid (in the case of diamine compound). Thus, the cross-linked polyaspartic acid composition can be produced. The hydrolysis reaction and the cross-linking reaction described above may be continuously performed in the same reactor, and an order of adding the raw materials and the like are not particularly limited.

The polysuccinimide composition (the composition containing the second polysuccinimide) obtained by the method for producing a polysuccinimide of the embodiment may be used as a polysuccinimide as it is. The polysuccinimide according to the embodiment may be hydrolyzed and cross-linked by the aforementioned methods, and used as a polyaspartic acid, a cross-linked polyaspartic acid, or a salt or derivative of the acids. Among these, the polyaspartic acid salt may be used as a raw material (for example, a thickener) for a cosmetic material. Examples of the cosmetic material include a skin care cosmetic material, a makeup cosmetic material, a hair care cosmetic material, and a body care cosmetic material, and specific examples include a skin toner, a cosmetic fluid, a milky lotion, a cream, a pack, an eyeliner, an eye shadow, a mascara, an eyebrow cosmetic, a foundation, a face powder, a makeup base, a cheek cosmetic, a facial wash, a hair styling agent, a hair coloring agent, a hair dye, a hair bleaching agent, a hair growth promoter, a shampoo, a treatment, a conditioner, a cleansing product, a lipstick, a gloss, a dentifrice, a teeth whitening agent, a sunscreen, a body powder, a body wash, a hand wash, a deodorant, and a bath cosmetic.

(Application of Polysuccinimide Composition (Composition containing Second Polysuccinimide) and Cross-Linked Polyaspartic Acid Composition)

The polysuccinimide composition (the composition containing the second polysuccinimide) and the cross-linked polyaspartic acid composition of the embodiment may be used, for example, for sanitary products such as a feminine hygiene product, a disposable diaper, a nursing pad, and a disposable cloth; medical products such as a dressing product for wound protection, a medical underpad, and a cataplasm; daily products such as a sheet for pet, a portable toilet, a gel fragrance, a gel deodorant, a sweat-absorbing fiber, and a disposable packet stove; toiletries such as a shampoo, a setting gel, and a humectant; agricultural and horticultural products such as an agricultural and horticultural water-retaining material, a plant growth aid, a cut-flower life-lengthening agent, a floral foam (a cut-flower fixing material), a raising nursery, a hydroponic vegetation sheet, a seed tape, a medium for fluid drilling, and a condensation-preventing agriculture sheet; food packaging materials such as a freshness-keeping material for food product tray and a drip-absorbing sheet; transportation materials such as a cold insulator and a water-absorbing sheet for transportation of fresh vegetables; constructional and building materials such as a condensation-preventing building material, a sealing material for construction and building, a lost circulation material for a shield method, a concrete admixture, a gasket and a packing; electrical apparatus-related materials such as an electronic apparatus, a sealing material such as an optical fiber, a water stop material for a communication cable, and an ink-jet recording sheet; water treatment agents such as a sludge coagulating agent, and a dehydrating or moisture content-removing agent of gasoline and oils; a printing paste, a water-swellable toy, man-made snow, a sustained release fertilizer, a sustained release pesticide, a sustained release medicament, a humidity adjusting material, an antistatic agent, and the like.

Among these, when the polysuccinimide composition (the composition containing the second polysuccinimide) and the cross-linked polyaspartic acid composition of the embodiment are used as a water-absorbing composition constituting an absorber of an absorbent article such as a diaper or a sanitary product, the size (average particle diameter) is preferably 1 μm to 5,000 μm, more preferably 10 μm to 1,000 μm, and further preferably 100 μm to 800 μm.

The polysuccinimide composition (the composition containing the second polysuccinimide) and the cross-linked polyaspartic acid composition of the embodiment may be used as a thickening composition such as a thickener for a cosmetic material. When the cross-linked polyaspartic acid composition of the embodiment is used as the thickening composition, the size (average particle diameter) is preferably 150 μm or less, more preferably 100 μm or less, and further preferably 80 μm or less.

### (Water-Absorbing Resin)

A water-absorbing resin of an embodiment of the present invention (the embodiment) contains the cross-linked polyaspartic acid composition of the aforementioned embodiment. The water-absorbing resin of the embodiment may contain another resin other than the cross-linked polyaspartic acid composition of the embodiment, another publicly known additive, or the like, if necessary.

When the cross-linked polyaspartic acid composition of the embodiment is a water-containing gel cross-linked product, the cross-linked product is dried, if necessary, and is generally pulverized before or after drying, to become a water-absorbing resin. A drying method is not particularly limited. For example, a publicly known method such as drying by heating, freeze-drying, drying under reduced pressure (in vacuum), or drying by heating under reduced pressure, can be optionally performed. The drying method is selected according to the purpose since the particle shape varies depending on the drying method. In the case of the drying by heating, the drying temperature falls within the range of generally 60° C. to 250° C., preferably 80° C. to 220° C., and more preferably 100° C. to 200° C. In the case of the drying by heating under reduced pressure, the drying temperature falls within the range of generally 50° C. to 200° C., preferably 60° C. to 150° C., and more preferably 70° C. to 120° C. The drying time depends on the surface area of the water-containing gel cross-linked product, the water content, and the kind of a dryer, and is selected so as to achieve a target water content. However, it is difficult that the water content of the water-absorbing resins is zero. Therefore, when the water-absorbing resin containing a small amount of water (for example, 0.3 wt % to 15 wt %, or 0.5 wt % to 10 wt %) is handled as a powder, the water-absorbing resin containing this amount of water as used herein is also referred to as water-absorbing resin.

In the water-absorbing resin of the embodiment, the content of the cross-linked polyaspartic acid composition of the embodiment is preferably 50 mass % to 100 mass %, more preferably 70 mass % to 100 mass %, and further preferably 90 mass % to 100 mass %. The water-absorbing resin of the embodiment may be the cross-linked polyaspartic acid composition of the embodiment.

### (Water-Absorbing Resin Particles)

Water-absorbing resin particles of an embodiment of the present invention (the embodiment) includes the water-absorbing resin of the aforementioned embodiment.

Examples of the shape of the water-absorbing resin particles of the embodiment include a nearly spherical shape, a crushed shape, and a granular shape. The size (average particle diameter) of the water-absorbing resin particles of the embodiment is preferably 1 μm to 5,000 μm, more preferably 10 μm to 1,000 μm, and further preferably 100 μm to 800 μm. The particle size distribution of the water-absorbing resin particles may be adjusted by performing an operation such as particle size adjustment based on classification using a sieve.

A cross-linker can be used to cross-link (surface cross-link) a surface portion of the water-containing gel cross-linked product in the water-absorbing resin particles of the embodiment. The surface cross-linking facilitates the control of water-absorbing property of the water-absorbing resin particles. The surface cross-linking is preferably performed when the water-containing gel cross-linked product has a specific water content.

Examples of the cross-linker (surface cross-linker) for performing surface cross-linking include the cross-linker used when the cross-linked polyaspartic acid composition of the embodiment is produced. Further examples include a compound having two or more other functional groups. The cross-linkers may be used alone or two or more types thereof may be used in combination.

Cross-linked product particles, which are a surface-cross-linked dried article, can be obtained by distilling water or a water-containing solvent by a publicly known method after the surface cross-linking.

The water-absorbing resin particles of the embodiment may include only the aforementioned cross-linked product particles, but may further contain, for example, a variety of type of additional component selected from a gel stabilizer, a metal chelate, and a fluidity enhancer (lubricant). The additional component may be disposed in the inside of the cross-linked product particles, on the surface of the cross-linked product particles, or in both the inside and the surface thereof. The additional component is preferably a fluidity enhancer (lubricant), and in particular, inorganic particles are more preferred. Examples of the inorganic particles include silica particles such as amorphous silica, talc, and mica.

The water-absorbing resin particles may contain a plurality of inorganic particles disposed on the surface of the cross-linked product particles. For example, the cross-linked product particles and the inorganic particles can be mixed to dispose the inorganic particles on the surface of the cross-linked product particles. The inorganic particles may be silica particles such as amorphous silica. When the water-absorbing resin particles contain the inorganic particles disposed on the surface of the cross-linked product particles, the ratio of the inorganic particles with respect to the mass of the cross-linked product particles may be 0.2 mass % or more, 0.5 mass % or more, 1.0 mass % or more, or 1.5 mass % or more, and may be 5.0 mass % or less, or 3.5 mass % or less. When the addition amount of the inorganic particles falls within the aforementioned range, water-absorbing resin particles having suitable water-absorbing properties can be easily obtained.

### (Absorber)

An absorber of an embodiment of the present invention (the embodiment) has the water-absorbing resin particles and a fibrous layer containing a fibrous substance. The absorber is, for example, a mixture containing the water-absorbing resin particles and the fibrous substance. The absorber may have, for example, a configuration in which the water-absorbing resin particles and the fibrous substance are uniformly mixed, a configuration in which the water-absorbing resin particles are disposed between sheets or layers formed of the fibrous substance, or another configuration.

The mass ratio of the water-absorbing resin particles in the absorber of the embodiment may be 2 mass % to 100 mass %, 10 mass % to 90 mass %, or 10 mass % to 80 mass %, with respect to the total amount of the water-absorbing resin particles and the fibrous substance.

The shape of the absorber of the embodiment is not particularly limited, and may be, for example, a sheet shape, a cylindrical shape, a film shape, or a fibrous shape. The thickness of the absorber (for example, the thickness of the sheet-shaped absorber) may be, for example, 0.1 mm to 50 mm or 0.3 mm to 30 mm.

For the absorber of the embodiment, the water-absorbing resin particles of the aforementioned embodiment are used. For the absorber of the embodiment, other publicly known water-absorbing resin particles may be used in addition to the water-absorbing resin particles of the aforementioned embodiment. It is preferable that the absorber of the embodiment contain only the water-absorbing resin particles of the aforementioned embodiment as water-absorbing resin particles.

From the viewpoint of more easily obtaining a sufficient liquid absorption performance when the absorber is used for an absorbent article described below, the content of the water-absorbing resin particles in the absorber of the embodiment is preferably 50 g to 2,000 g per square meter of the absorber (that is, 50 g/m² to 2,000 g/m²), more preferably 100 g/m² to 1,000 g/m². From the viewpoint of exerting a sufficient liquid absorption performance of the absorbent article, particularly suppressing liquid leakage, the content of the water-absorbing resin particles is preferably 50 g/m² or more. From the viewpoint of suppressing a gel blocking phenomenon, exerting the liquid dispersion performance of the absorbent article, and further improving the liquid permeation speed, the content of the water-absorbing resin particles is preferably 2,000 g/m² or less.

### [Fibrous Substance]

Examples of the fibrous substance include, but not particularly limited to, fine pulverized wood pulp; cotton; cotton linter; rayon; gossypium; wool; acetate; vinylon; cellulosic fibers such as cellulose acetate; synthetic fibers such as polyamide, polyester, and polyolefin; and mixtures of these fibers. The fibrous substance may be used alone or two or more types thereof may be used in combination. As the fibrous substance, hydrophile fibers may be used.

From the viewpoint of obtaining a sufficient liquid absorption performance when the absorber is used for the absorbent article described below, the content of the fibrous substance is preferably 50 g to 800 g per square meter of the absorber (that is, 50 g/m² to 800 g/m²), more preferably 100 g/m² to 600 g/m², and further preferably 150 g/m² to 500 g/m². From the viewpoint of exerting a sufficient liquid absorption performance of the absorbent article, particularly suppressing a gel blocking phenomenon to enhance a liquid diffusion performance, and further enhancing the strength of the absorber after liquid absorption, the content of the fibrous substance is preferably 50 g or more per square meter of the absorber (that is, 50 g/m² or more). In particular, from the viewpoint of suppressing flowback after the liquid absorption, the content of the fibrous substance is preferably 800 g or less per square meter of the absorber (that is, 800 g/m² or less).

In order to enhance form retentivity before and during use of the absorber, fibers may be bonded to each other by adding an adhesive binder to the fibrous substance. Examples of the adhesive binder include thermally fusible synthetic fibers, a hot-melt adhesive, and an adhesive emulsion. The adhesive binders may be used alone or two or more types thereof may be used in combination.

Examples of the thermally fusible synthetic fibers include complete melting type binders such as polyethylene, polypropylene, and an ethylene-propylene copolymer; and non-complete melting type binders formed of polypropylene and polyethylene in a side-by-side or core-sheath structure. By the aforementioned non-complete melting type binder, a polyethylene portion alone may be thermally fused.

Examples of the hot-melt adhesive include mixtures of a base polymer such as an ethylene-vinyl acetate copolymer, a styrene-isoprene-styrene block copolymer, a styrene-butadiene-styrene block copolymer, a styrene-ethylene-butylene-styrene block copolymer, a styrene-ethylene-propylene-styrene block copolymer, or an amorphous polypropylene, with a tackifying agent, a plasticizer, an antioxidant, or the like.

Examples of the adhesive emulsion include a polymer of at least one type of monomer selected from the group consisting of methyl methacrylate, styrene, acrylonitrile, 2-ethylhexyl acrylate, butyl acrylate, butadiene, ethylene, and vinyl acetate.

### [Additive]

The absorber of the embodiment may further contain various types of additives that are generally used in the art, such as an inorganic powder, a deodorant, a pigment, a dye, a flavor, an anti-microbial agent, and a tackiness agent. These additives can impart various functions to the absorber. Examples of the inorganic powder include silicon dioxide, zeolite, mica, kaolin, and clay. When the water-absorbing resin particles contain inorganic particles, the absorber may contain an inorganic powder separately from the inorganic particles in the water-absorbing resin particles.

### (Absorbent Article)

An absorbent article of an embodiment of the present invention (the embodiment) includes the absorber, a liquid-permeable sheet disposed at the outermost portion on a side of entry of a liquid to be absorbed, and a liquid-impermeable sheet disposed at the outermost portion on a side opposite to the side of entry of a liquid to be absorbed. Examples of the absorbent article include a diaper (for example, a disposable diaper), a training pant, an incontinence pad, a urine absorbing sheet, a urine absorbing liner, a sanitary material (sanitary napkin, tampon, etc.), a sweat pad, a sheet for pet, a member for a portable toilet, and an animal excreta treatment material.

The absorbent article includes the liquid-impermeable sheet, the absorber, and the liquid-permeable sheet laminated in this order.

For the absorbent article of the embodiment, the absorber of the aforementioned embodiment is used. For the absorbent article of the embodiment, another publicly known absorber may be used in addition to the absorber of the aforementioned embodiment. For the absorbent article of the embodiment, only the absorber of the aforementioned embodiment is preferably used as an absorber. [Liquid-Permeable Sheet]

The liquid-permeable sheet is disposed at the outermost portion on the side of entry of a liquid to be absorbed. For example, the liquid-permeable sheet has a wider main surface than the main surface of the absorber, and an outer edge extending the periphery of the absorber.

The liquid-permeable sheet may be a sheet formed of a resin or fibers generally used in the art. From the viewpoint of liquid permeability, flexibility, and strength during use of the liquid-permeable sheet for the absorbent article, the liquid-permeable sheet may contain a synthetic resin such as a polyolefin such as a polypropylene (PE) or a polyethylene (PP), a polyester such as polyethylene terephthalate (PET), polytrimethylene terephthalate (PTT), polyethylene naphthalate (PEN), polybutylene adipate terephthalate (PBAT), polybutylene succinate (PBS), polybutylene succinate adipate (PBSA), polylactic acid, or polyhydroxyalkanoate, a polyamide such as nylon, or rayon, or synthetic fibers containing the synthetic resin, or may be natural fibers containing cotton, silk, hemp, or pulp (cellulose). From the viewpoint of enhancing the strength of the liquid-permeable sheet, the liquid-permeable sheet may contain the synthetic fibers. In particular, the synthetic fibers may be polyolefin fibers, polyester fibers, or a combination thereof. The materials may be used alone or two or more types thereof may be used in combination.

The liquid-permeable sheet may be a nonwoven fabric, a porous sheet, or a combination thereof. The nonwoven fabric is a sheet in which fibers are entangled without weaving. The nonwoven fabric may be a nonwoven fabric (staple-nonwoven fabric) formed of short fibers (that is, staple), or a nonwoven fabric (filament-nonwoven fabric) formed of long fibers (that is, filament). The staple is not limited to this fiber, but may generally have a fiber length of several hundred millimeters or less.

The liquid-permeable sheet may be at least one type of nonwoven fabric selected from the group consisting of a thermally bond nonwoven fabric, an air-through nonwoven fabric, a resin-bonded nonwoven fabric, a spunbonded nonwoven fabric, a melt-blown nonwoven fabric, a spunbonded/melt-blown/spunbonded nonwoven fabric, an air-laid nonwoven fabric, a spunlaced nonwoven fabric, and a point-bonded nonwoven fabric, and is preferably at least one type of nonwoven fabric selected from the group consisting of a thermally bond nonwoven fabric, an air-through nonwoven fabric, a spunbonded nonwoven fabric, and a spunbonded/melt-blown/spunbonded nonwoven fabric.

The liquid-permeable sheet may be a thermally bond nonwoven fabric, an air-through nonwoven fabric, a resin-bonded nonwoven fabric, a spunbonded nonwoven fabric, a melt-blown nonwoven fabric, an air-laid nonwoven fabric, a spunlaced nonwoven fabric, a point-bonded nonwoven fabric, or a laminate of two or more types of nonwoven fabrics selected from these nonwoven fabrics. The nonwoven fabrics may be, for example, those formed from the aforementioned synthetic fibers or natural fibers. The laminate of two or more types of nonwoven fabrics may be a spunbonded/melt-blown/spunbonded nonwoven fabric, which is a composite nonwoven fabric in which a spunbonded nonwoven fabric, a melt-blown nonwoven fabric, and the spunbonded nonwoven fabric are laminated in this order. Among these, from the viewpoint of suppressing liquid leakage, a thermally bond nonwoven fabric, an air-through nonwoven fabric, a spunbonded nonwoven fabric, or a spunbonded/melt-blown/spunbonded nonwoven fabric is preferably used.

From the viewpoint of liquid absorption performance of the absorbent article, it is desirable that a nonwoven fabric used as the liquid-permeable sheet have moderate hydrophilicity.

The nonwoven fabric having such hydrophilicity may be, for example, a nonwoven fabric formed of fibers having a moderate hydrophilicity such as rayon fibers, or a nonwoven fabric formed of fibers obtained by a hydrophilic treatment of hydrophobic chemical fibers such as polyolefin fibers or polyester fibers. Examples of a method for obtaining a nonwoven fabric containing hydrophobic chemical fibers that are subjected to a hydrophilic treatment include a method for obtaining a nonwoven fabric by a spunbonding method using a mixture of a hydrophobic chemical fibers and a hydrophilic agent, a method in which a spunbonded nonwoven fabric is formed of hydrophobic chemical fibers with a hydrophilic agent, and a method in which a spunbonded nonwoven fabric formed of hydrophobic chemical fibers is impregnated with a hydrophilic agent. As a hydrophilic agent, a stain releasing agent including an anionic surfactant such as an aliphatic sulfonate or a higher alcohol sulfate, a cationic surfactant such as a quaternary ammonium salt, a nonionic surfactant such as a polyethylene glycol fatty acid ester, a polyglycerol fatty acid ester, or a sorbitan fatty acid ester, a silicone surfactant such as a polyoxyalkylene-modified silicone, and a polyester-based, polyamide-based, acrylic, or urethane-based resin, or the like is used.

From the viewpoint of imparting favorable liquid permeability, flexibility, strength, and cushioning property to the absorbent article, and from the viewpoint of increasing the liquid permeation speed of the absorbent article, the liquid-permeable sheet is preferably a nonwoven fabric having a moderate bulk and a large basis weight.

### [Liquid-Impermeable Sheet]

The liquid-impermeable sheet is disposed at the outermost portion of the absorbent article on a side opposite to the liquid-permeable sheet. For example, the liquid-impermeable sheet has a wider main surface than the main surface of the absorber, and an outer edge extending the periphery of the absorber. The liquid-impermeable sheet prevents leakage of a liquid absorbed by the absorber from the side of the liquid-impermeable sheet to the outside.

Examples of the liquid-impermeable sheet include sheets formed of resins such as a polyethylene, a polypropylene, a polyvinyl chloride, a polylactic acid, and a polyhydroxyalkanoate, sheets formed of nonwoven fabrics such as a spunbonded/melt-blown/spunbonded (SMS) nonwoven fabric in which a water-resistant melt-blown nonwoven fabric is disposed between high-strength spunbonded nonwoven fabrics, and sheets formed of composite materials of the resins and the nonwoven fabrics (for example, a spunbonded nonwoven fabric and a spunlaced nonwoven fabric). From the viewpoint of suppressing stuffiness during fitting to reduce discomfort felt by a wearer, the liquid-impermeable sheet is preferably air-permeable. As the liquid-impermeable sheet, a sheet formed of a synthetic resin mainly including a low-density polyethylene (LDPE) resin may be used.

The sizes of the absorber, the liquid-permeable sheet, and the liquid-impermeable sheet are not particularly limited, and are appropriately adjusted according to the application of the absorbent article, and the like.

### EXAMPLES

Hereinafter, the present invention will be described in more detail using Examples, but the present invention is not limited to the examples.

### (Reactor)

Continuous kneader: “KRC kneader” manufactured by Kurimoto, Ltd.
Vacuum dryer: manufactured by AS ONE Corporation
Conical dryer: Ribocone manufactured by Okawara Mfg. Co., Ltd.
Vibration dryer: manufactured by Chuo Kakohki Co., Ltd.
Fluidized bed dryer: manufactured by Kurimoto, Ltd.

### (Measurement Method)

### [Method for Measuring Weight Average Molecular Weight]

The weight average molecular weight (Mw) of a polysuccinimide was measured by gel permeation chromatography (GPC) using a polysaccharide polymer (pullulan) as a standard after the polysuccinimide was dissolved in a 15% sodium hydroxide aqueous solution.
Device: HLC-8420GPC (Tosoh Corporation)
Detector: differential refractometer
Column: Shodex Asahipak Guard column GF-1G 7B, GF-7MHQ×3, Reference column: SB-800HQ×3
Solvent: 0.1 M saline solution
Concentration: 0.2 wt % to 1.0 wt %
Injection volume: 10 μL
Flow rate: 1.0 ml/min

### [Method for Measuring Dicarboxylic Acid Amount]

The dicarboxylic acid amount was measured using ¹HNMR manufactured by JEOL Ltd. 0.1 g of polysuccinimide sample was dissolved in 0.6 mL of deuterated dimethylsulfoxide to produce a measurement sample, and measurement was performed at 60° C. From the resultant 1HNMR spectrum result, the amounts of a backbone peak, a peak of an end group such as a dicarboxyl group, and peaks based on a side reaction such as a maleimide end-group peak, and a succinimide end-group peak are identified, and from the ratio with the respect to the whole, the amount of dicarboxyl group was calculated.

### Example 1

### First Step

A mixture obtained by mixing 60 mol % of 85% phosphoric acid in 1 mol of L-aspartic acid was subjected to the following procedure using “KRC kneader” manufactured by Kurimoto, Ltd., as a continuous kneader. A heating medium was set to 195° C., and the rotation number of a screw was set to 30 rpm. Nitrogen was fed at 10 L/min, and the obtained mixture of aspartic acid and phosphoric acid was supplied so that the discharge amount was 1 kg/h, resulting in polycondensation, and a slightly brown solid polymer (a polysuccinimide composition containing the first polysuccinimide) was obtained. It took about 10 minutes from feeding the raw material until first discharge at the outlet. The solid polymer was pulverized with an electric pulverizer, the resultant powder was cleaned three times with ion exchanged water in an amount 3 times the weight of the powder to remove phosphoric acid, and the molecular weight was measured by GPC. The weight average molecular weight of the first polysuccinimide was 26,400. The obtained solid polymer (the polysuccinimide composition containing the first polysuccinimide) was subjected to measurement by 1H-NMR, and as a result, the dicarboxylic acid amount was 3.7 mol %. The results are shown in Table 1.

### Second Step

The polymer obtained in the first step (the polysuccinimide composition containing the first polysuccinimide) was pulverized with an electric pulverizer, and dehydrated and condensed with a vacuum dryer, resulting in an increase in molecular weight. Polymerization was caused at a setting temperature of 190° C. and a degree of vacuum of 1,333 Pa for 6 hours, to obtain a polysuccinimide having a weight average molecular weight of 127,300 and no branch.

The presence or absence of branch can be judged, for example, by the measurement of an amide NH amount through 1H-NMR measurement in accordance with a publicly known method (Macromolecules, Vol. 30, No. 8, 1997 pp. 2305-2312). From a peak amount of 8.1 ppm to 9.2 ppm, it was confirmed that the NH amount was 0, and the absence of branch was determined.
NPL B: Macromolecules, Vol. 30, No. 8, 1997 pp. 2305-2312

### Examples 2 to 6 and Comparative Examples 1 to 2 and 4 to 5

A polysuccinimide of each of Examples 2 to 6 and Comparative Examples 1 to 5 was obtained in the same manner as in Example 1 except for reaction conditions in the first step and reaction conditions in the second step shown in Table 1. In Examples 2, 4, 5, and 6, the reaction conditions in the first step were the same, but the screw configuration of the continuous kneader was changed. For this reason, a difference in physical properties of the obtained polysuccinimides was produced as a result.

The dicarboxylic acid amount of the polysuccinimide composition obtained in the first step and the weight average molecular weight of the first polysuccinimide contained in the polysuccinimide composition were measured in the same manner as in Example 1. The weight average molecular weight of the second polysuccinimide obtained in the second step was measured. The results are shown in Table 1.

In Comparative Examples 4 and 5, the polysuccinimide composition containing the second polysuccinimide was not obtained since the device was stopped and the content did not flow and the reaction was stopped in the second step.

### Comparative Example 3

A polysuccinimide shown in Comparative Example 3 was obtained by reacting the polymer obtained in the first step (the polysuccinimide composition containing the first polysuccinimide) again in the continuous kneader under the reaction conditions shown in Table 1 as the second step. The weight average molecular weight of the polysuccinimide obtained in the second step was measured. A largely increased weight average molecular weight was not seen.

TABLE 1

| | | | | Ex. 1 | Ex. 2 | Ex. 3 | EX. 4 | Ex. 5 | Ex. 6 | Ex. 7 |
|---|---|---|---|---|---|---|---|---|---|---|
| First | Reaction | Reactor | | CK | CK | CK | CK | CK | CK | CK |
| Step | conditions | Phosphoric | mol % | 60 | 60 | 60 | 60 | 60 | 60 | 30 |
| | | acid ratio | | | | | | | | |
| | | Setting | ° C. | 195 | 200 | 210 | 200 | 200 | 200 | 230 |
| | | temperature | | | | | | | | |
| | | Feed rate | kg/h | 1 | 1 | 1 | 1 | 1 | 1 | 1 |
| | | Nitrogen | L/min | 10 | 10 | 10 | 10 | 10 | 10 | 10 |
| | Evaluation | Weight | | 26,400 | 33,800 | 38,500 | 37,600 | 43,000 | 37,600 | 40,000 |
| | | average | | | | | | | | |
| | | molecular | | | | | | | | |
| | | weight | | | | | | | | |
| | | Dicarboxylic | mol % | 3.7 | 2.7 | 2.1 | 2.3 | 2.3 | 2.3 | 1.5 |
| | | acid amount | | | | | | | | |
| Second | Reaction | Reactor | | VD | VD | VD | VD | CD | Vr [symbol] | VD |
| Step | conditions | Additional | mol % | 0 | 0 | 0 | 0 | 0 | 0 | 30 |
| | | amount of | | | | | | | | |
| | | phosphoric | | | | | | | | |
| | | acid | | | | | | | | |
| | | Setting | ° C. | 190 | 190 | 190 | 190 | 290 | 190 | 190 |
| | | temperature | | | | | | | | |
| | | Vacuum | Pa | 1333 | 1333 | 1333 | 1333 | 1333 | 1333 | 1333 |
| | | degree | | | | | | | | |
| | | Time | h | 6 | 6 | 6 | 6 | 4.5 | 6 | 6 |
| | Evaluation | Weight | — | 127,300 | 126,000 | 107,400 | 141,000 | 142,500 | 130,600 | 105,000 |
| | | average | | | | | | | | |
| | | molecular | | | | | | | | |
| | | weight | | | | | | | | |
| | | | | | | Comp. | Comp. | Comp. | Comp. | Comp. |
| | | | | | | Ex. 1 | Ex. 2 | Ex. 3 | Ex. 4 | Ex. 5 |
| | | First | Reaction | Reactor | | CK | CK | CK | CK | CK |
| | | Step | conditions | Phosphoric | mol % | 60 | 60 | 60 | 60 | 60 |
| | | | | acid ratio | | | | | | |
| | | | | Setting | ° C. | 210 | 230 | 210 | 230 | 230 |
| | | | | temperature | | | | | | |
| | | | | Feed rate | kg/h | 1 | 1 | 2 | 2 | 2 |
| | | | | Nitrogen | L/min | 10 | 10 | 10 | 10 | 10 |
| | | | Evaluation | Weight | | 59,200 | 50,200 | 59,200 | 20,200 | 20,200 |
| | | | | average | | | | | | |
| | | | | molecular | | | | | | |
| | | | | weight | | | | | | |
| | | | | Dicarboxylic | mol % | 0.97 | 1.2 | 0.97 | 2.1 | 2.1 |
| | | | | acid amount | | | | | | |
| | | Second | Reaction | Reactor | | VD | VD | CK | CD | FD |
| | | Step | conditions | Additional | mol % | 0 | 0 | 0 | 0 | 0 |
| | | | | amount of | | | | | | |
| | | | | phosphoric | | | | | | |
| | | | | acid | | | | | | |
| | | | | Setting | ° C. | 190 | 190 | 210 | 190 | 190 |
| | | | | temperature | | | | | | |
| | | | | Vacuum | Pa | 1333 | 1333 | 0.25 | 1333 | — |
| | | | | degree | | | | | | |
| | | | | Time | h | 6 | 6 | 10 | | |
| | | | | | | | | (in | | |
| | | | | | | | | nitrogen) | | |
| | | | Evaluation | Weight | — | 79,600 | 60,800 | 63,770 | Device | Com- |
| | | | | average | | | | | was | position |
| | | | | molecular | | | | | stopped. | did not |
| | | | | weight | | | | | | flow. |
| | | | | | | | | | | Device |
| | | | | | | | | | | was |
| | | | | | | | | | | stopped. |

[symbol]

indicates data missing or illegible when filed

Meanings of reference characters in Table 1
CK: continuous kneader “KRC kneader” manufactured by Kurimoto, Ltd.
VD: vacuum dryer manufactured by AS ONE Corporation
CD: conical dryer Ribocone manufactured by Okawara Mfg. Co., Ltd.
VrD: vibration dryer manufactured by Chuo Kakohki Co., Ltd.
FD: Fluidized bed dryer

### CONSIDERATION

In Examples 1 to 7, the polysuccinimide composition containing the first polysuccinimide and having a weight average molecular weight of 25,000 to 50,000 was obtained by polycondensation of the mixture of aspartic acid and phosphoric acid in the first step, as shown in Table 1. The polysuccinimide composition containing the second polysuccinimide and having a weight average molecular weight of 100,000 to 150,000 was produced by promoting an increase in molecular weight in the second step using the polysuccinimide composition as it was.

In contrast, in Comparative Examples 1 to 2, the weight average molecular weight of the first polysuccinimide obtained in the first step was more than 50,000. For the polysuccinimide composition containing the second polysuccinimide, which was produced using the polysuccinimide composition, an increase in molecular weight was hardly promoted, and the weight average molecular weight was 80,000 or less. This was considered because an increase in molecular weight does not advance in the chain elongation reaction of the second step due to an insufficient dicarboxylic acid amount of the polysuccinimide contained in the first polysuccinimide obtained in the first step. It is found that in Comparative Example 3, a high molecular weight polymer is not obtained even by performing a reaction again in the continuous kneader.

In Comparative Examples 4 to 5, the weight average molecular weight of the first polysuccinimide obtained in the first step was less than 25,000. The reaction of the second step was performed using the polysuccinimide composition, but the device was stopped, the composition did not flow and the reaction was stopped, the final product was not obtained. The first polysuccinimide having a molecular weight of about 20,000 and containing a phosphoric acid, which was obtained in the first step, was in a very viscous state when the reaction temperature was increased to 190° C. Therefore, in addition to the coagulation of powder, the powder was likely to be attached to a stirring blade and a reaction wall, did not flow in a fluidized bed dryer, and the torque of a stirring blade in a rotary dryer was significantly increased. This stopped a continued reaction.

On the other hand, in Examples 5 to 6, the polysuccinimide having a weight average molecular weight of 25,000 or more was obtained by polycondensation of the mixture of aspartic acid and phosphoric acid in the first step. In general, the molecular weight of a polymer affects Tg of the polymer, and a higher molecular weight has higher Tg. An increase in Tg very sensitively affects the coagulation of the power and the attachment of the powder to the reactor. It is presumed that the difference as described above allows for an increase in molecular weight using the dryer in Examples 5 to 6, and the difference stops the device and fails to produce the final product in Comparative Examples 4 to 5.

According to the present invention, a method for producing a polysuccinimide that can simply produce a high molecular weight polysuccinimide can be provided.

1. A method for producing a polysuccinimide in which a second polysuccinimide is produced using a polysuccinimide composition containing a first polysuccinimide, the method comprising:
performing a chain elongation reaction of the first polysuccinimide to obtain the second polysuccinimide,
the first polysuccinimide having a weight average molecular weight (Mw) falling within a range of 25,000 to 50,000, the polysuccinimide composition containing dicarboxylic acid at a ratio of 1.5 mol % to 4 mol %.

2. The method for producing a polysuccinimide according to claim 1, the method further comprising:
performing a polycondensation reaction of aspartic acid to obtain the polysuccinimide composition containing the first polysuccinimide, as a first step, before the chain elongation reaction, as a second step, wherein
the first step and the second step are performed using different devices.

3. The method for producing a polysuccinimide according to claim 2, wherein at a stage in which the weight average molecular weight (Mw) of the first polysuccinimide in the first step falls within a range of 25,000 to 50,000 and the ratio of dicarboxylic acid in the first polysuccinimide falls within a range of 1.5 mol % to 4 mol %, the first step ends and proceeds to the second step.

4. The method for producing a polysuccinimide according to claim 2, wherein the first step is performed using a continuous kneader.

5. The method for producing a polysuccinimide according to claim 1, wherein the chain elongation reaction is performed using at least one device selected from the group consisting of a hot-air-transferring dryer, a material-stirring dryer, a fluidized bed dryer, a material-ventilation and transferring dryer, a cylindrical dryer, an infrared ray dryer, a microwave dryer, and an overheated-steam dryer.

6. A polysuccinimide composition comprising a second polysuccinimide having a weight average molecular weight falling within a range of 100,000 to 500,000, the polysuccinimide composition being obtained by the method for producing a polysuccinimide according to claim 1.

7. A polyaspartic acid composition that is a hydrolysate of the polysuccinimide composition according to claim 6.

8. A cross-linked polyaspartic acid composition that is a cross-linking reaction product of the polyaspartic acid composition according to claim 7.

9. A thickener for a cosmetic material comprising the cross-linked polyaspartic acid composition according to claim 8.

10. A water-absorbing composition comprising the cross-linked polyaspartic acid composition according to claim 8.

11. The method for producing a polysuccinimide according to claim 3, wherein the first step is performed using a continuous kneader.

12. The method for producing a polysuccinimide according to claim 2, wherein the chain elongation reaction is performed using at least one device selected from the group consisting of a hot-air-transferring dryer, a material-stirring dryer, a fluidized bed dryer, a material-ventilation and transferring dryer, a cylindrical dryer, an infrared ray dryer, a microwave dryer, and an overheated-steam dryer.

13. A polysuccinimide composition comprising a second polysuccinimide having a weight average molecular weight falling within a range of 100,000 to 500,000, the polysuccinimide composition being obtained by the method for producing a polysuccinimide according to claim 2.

14. A polyaspartic acid composition that is a hydrolysate of the polysuccinimide composition according to claim 13.

15. A cross-linked polyaspartic acid composition that is a cross-linking reaction product of the polyaspartic acid composition according to claim 14.

16. A thickener for a cosmetic material comprising the cross-linked polyaspartic acid composition according to claim 15.

17. A water-absorbing composition comprising the cross-linked polyaspartic acid composition according to claim 15.
